(19) United States
(12) Patent Application Publication
(10) Pub. No.: US 2024/0055609 A1
(43) Pub. Date: Feb. 15, 2024

(54) AQUEOUS PRIMARY BATTERY

(71) Applicant: Panasonic Intellectual Property Management Co., Ltd., Osaka-shi, Osaka (JP)

(72) Inventor: Yasuyuki Kusumoto, Hyogo Ken (JP)

(73) Assignee: Panasonic Intellectual Property Management Co., Ltd., Osaka-shi, Osaka (JP)

(21) Appl. No.: 18/266,701

(22) PCT Filed: Aug. 5, 2021
(86) PCT No.: PCT/JP2021/029089

§ 371 Date: Jun. 12, 2023

(30) Foreign Application Priority Data
Dec. 16, 2020 (JP) 2020-208093

(51) Int. Cl. H01M 4/60; H01M 6/06; H01M 4/24

(52) U.S. Cl. CPC H01M 4/608; H01M 6/06; H01M 4/244

(57) ABSTRACT

An aqueous primary battery includes a positive electrode, a negative electrode, a separator interposed between the positive electrode and the negative electrode, and an aqueous solution electrolyte included in the positive electrode, the negative electrode, and the separator, wherein the negative electrode and/or the electrolyte includes an additive, the negative electrode includes a negative electrode active material, the negative electrode active material includes zinc, the additive includes a cyclic compound, and the cyclic compound has a first ring including a —N—CO— structure, and a second ring that shares at least two atoms with the first ring.

### TECHNICAL FIELD

The present disclosure relates to an aqueous primary battery having an aqueous solution electrolyte.

### BACKGROUND ART

For aqueous primary batteries (e.g., alkaline dry battery) having a negative electrode active material including zinc and an aqueous solution electrolyte, expiration date for use for undischarged batteries is ten years at maximum in an undischarged state. A reason for setting the expiration date for use is an increase in the internal pressure of the battery. During long-term storage, zinc contained in the negative electrode of aqueous primary batteries reacts gradually with water, and constantly generates a trace amount of hydrogen gas. When the gas accumulates for a long time in the battery, the battery internal pressure increases and causes leakage.

Patent Literature 1 has proposed an alkaline battery having a negative electrode material including a zinc alloy powder and an electrolyte, wherein 0.001 to 5.0 parts by weight of a polyoxyethylene alkyl ether phosphoric acid ester is added relative to 100 parts by weight of the zinc alloy powder. Patent Literature 1 aims to provide an alkaline battery in which the mercury content is significantly reduced, the hydrogen gas generation is suppressed, and discharge performance is kept at a high level; and a negative electrode active material thereof.

Patent Literature 2 has proposed an alkaline dry battery composed of a positive electrode including at least one of a manganese dioxide powder and an nickel oxy hydroxide powder; a negative electrode including a zinc alloy powder; a separator disposed between the positive electrode and the negative electrode; an alkaline electrolyte; a metal case mainly composed of iron; a layer including nickel and formed at the inner surface of the metal case; and a battery case accommodating the positive electrode, negative electrode, separator, and alkaline electrolyte, wherein the negative electrode includes a surfactant that adsorbs to the zinc alloy powder surface while not discharging, and desorbs quickly from the zinc alloy powder surface at the start of discharging without distracting movement of ions in the alkaline electrolyte.

### CITATION LIST

### Patent Literature

PLT1: Japanese Laid-Open Patent Publication No. H2-82452
PLT2: Japanese Laid-Open Patent Publication No. 2008-34375

### SUMMARY OF INVENTION

With the polyoxyethylene alkyl ether phosphoric acid ester and surfactant recommended in Patent Literatures 1 and 2, the effects of preventing leakage at the time of long-term storage are insufficient for the aqueous primary battery in which the negative electrode active material includes zinc, and which includes an aqueous solution electrolyte.

An aspect of the present disclosure relates to an aqueous primary battery including a positive electrode, a negative electrode, a separator disposed between the positive electrode and the negative electrode, an aqueous solution electrolyte included in the positive electrode, the negative electrode, and the separator, wherein the negative electrode and/or the electrolyte includes an additive, the negative electrode includes a negative electrode active material, the negative electrode active material includes zinc, the additive includes a cyclic compound, the cyclic compound has a first ring including a —N—CO— structure, and a second ring that shares at least two atoms with the first ring.

With the present disclosure, even when an aqueous primary battery in which a negative electrode active material includes zinc and which includes an aqueous solution electrolyte is stored for a long time, liquid leakage can be suppressed.

### BRIEF DESCRIPTION OF DRAWINGS

FIG. 1 is a front view, partially shown in cross section, of an alkaline dry battery in one embodiment of the present invention.

### DESCRIPTION OF EMBODIMENTS

An aqueous primary battery in an embodiment of the present disclosure includes a positive electrode, a negative electrode, a separator disposed between the positive electrode and the negative electrode, and an aqueous solution electrolyte (hereinafter, may be simply referred to as an electrolyte) included in the positive electrode, the negative electrode, and the separator. The aqueous primary battery includes a general primary battery having an aqueous solution electrolyte. The aqueous solution electrolyte includes water as a main component of the solvent. The main component of the solvent means a component that shares 50 mass % or more, 70 mass % or more, or even 90 mass % or more of the solvent.

The negative electrode includes a negative electrode active material, and the negative electrode active material includes zinc. Zinc gradually reacts with water in the electrolyte, and constantly generates a trace amount of hydrogen gas. When aqueous primary batteries are stored for a long period of time, hydrogen gas accumulates in the battery, and the battery internal pressure increases. When the battery internal pressure reaches a predetermined threshold, for example, the safety valve included in the battery acts or a gap is caused at the sealing portion such as crimp portion and the gas in the battery is released to the outside. The liquid leakage may occur at that time.

To cope with this, in this embodiment, the negative electrode and/or electrolyte includes an additive. The additive includes a cyclic compound. The cyclic compound has a first ring including a —N—CO— structure (i e, amide bond), and a second ring that shares at least two atoms with the first ring. CO in the —N—CO— structure is a carbonyl group. Each of the shared atom is a constituent atom of the first ring, and also is a constituent atom of the second ring.

It is assumed that the cyclic compound generates anions in the electrolyte. The negative charge of the anions localize on the nitrogen of the —N—CO— structure. The negatively charged nitrogen included in the first ring is easy to electrically interact with metals, and therefore anions of the cyclic compound easily adsorb to the zinc surface. The second ring adjacent to the first ring adsorbed to the zinc surface can be a hindrance to generation of hydrogen gas and zinc complex ions (Zn(OH)₄²⁻) by reaction of zinc and water. Also, anions of the cyclic compound may form a complex (Zn(MA)₄²⁻(where MA is an anion of the cyclic compound)) with zinc ions in the electrolyte. The complex is bulky, and is assumed to be present near the negative electrode active material. Such a complex may become a sufficient hindrance to protect the zinc surface, and may work to reduce dissolution activity of zinc. Based on the above, the increase in the battery internal pressure due to the hydrogen gas generation is suppressed, and the liquid leakage is suppressed.

The phosphoric acid ester and surfactant proposed by Patent Literatures 1 and 2 have a relatively low adsorption to the zinc surface, and a complex may not be easily formed.

The cyclic compound may have only the first ring and the second ring, and may have further one or more (i.e., a total of three or more) rings. The cyclic compound may have, for example, a total of 2 to 4 rings, or 2 to 3 rings.

The first ring and the second ring preferably are, in terms of structural stability, each independently a 5-membered ring, a 6-membered ring, or a 7-membered ring. The second ring may be an aliphatic ring or aromatic ring. The aliphatic ring may be cycloalkane or cycloalkene. The aromatic ring may be, for example, a benzene ring, and may be a part of a condensed ring or polycyclic ring. The second ring may be, for example, a part of a condensed ring such as naphthalene and anthracene.

The cyclic compound may be, for example, at least one selected from the group consisting of a phthalimide compound, a phthalimidine compound, and a tetrahydro phthalimide compound below. These cyclic compounds easily go through ionization in the electrolyte, and generate anions having negative charge localized on nitrogen.

The phthalimide compound is represented by a general formula (1):

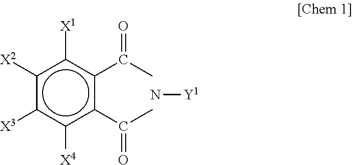

(in the general formula (1), X1 to X4 are each independently a hydrogen atom, a fluorine atom, a chlorine atom, a bromine atom, an iodine atom, or an alkyl group having 1 to 3 carbon atoms, and Y1 is a hydrogen atom or an alkali metal atom).

The phthalimidine compound is represented by a general formula (2):

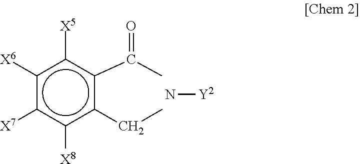

(in the general formula (2), X5 to X8 are each independently a hydrogen atom, a fluorine atom, a chlorine atom, a bromine atom, an iodine atom, or an alkyl group having 1 to 3 carbon atoms, and Y2 is a hydrogen atom or an alkali metal atom).

The tetrahydro phthalimide compound is represented by a general formula (3):

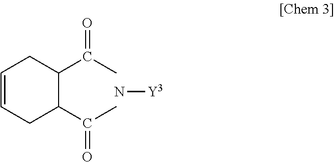

(in the general formula (3), Y3 is a hydrogen atom or an alkali metal atom).

X1 to X8 are, for example, each independently a methyl group, an ethyl group, or a n-propyl group.

More specifically, the cyclic compound may be, for example, at least one selected from the group consisting of phthalimide and potassium phthalimide. These are preferable because they are easily commercially available.

The amount of the cyclic compound included in the battery is not particularly limited, and for example, 0.005 parts by mass or more and 0.05 parts by mass or less is a suitable amount; it may be 0.01 parts by mass or more and 0.05 parts by mass or less, or may be 0.015 parts by mass or more and 0.04 parts by mass or less relative to 100 parts by mass of the negative electrode active material.

The negative electrode and/or electrolyte may include, in addition to the cyclic compound, at least one selected from the group consisting of phthalic acid, ammonia, and ammonium carbonate. The amount of phthalic acid included in the battery is, for example, preferably 0.1 mass % or less relative to 100 parts by mass of the negative electrode active material. The amount of ammonia and ammonium carbonate included in the battery is, for example, preferably 0.001 mass % or less in total relative to 100 parts by mass of the negative electrode active material.

Typical examples of the aqueous primary battery include manganese dry batteries and alkaline dry batteries (alkaline manganese dry batteries). These include manganese dioxide as the positive electrode. The manganese dry battery has a zinc can as the negative electrode including the positive electrode therein, and has a carbon rod inserted in the positive electrode. The alkaline dry battery has a gel negative electrode included in a cylindrical positive electrode.

The form of the aqueous primary battery may be, without particular limitation, a cylindrical battery, a flat battery, a prismatic battery, and a coin battery.

A zinc powder and a zinc alloy powder may be used as the negative electrode active material. In view of anticorrosion, the zinc alloy may include, for example, at least one selected from the group consisting of tin, indium, bismuth, and aluminum. The indium content in the zinc alloy is, for example, 0.01 to 0.1 mass %. The bismuth content in the zinc alloy is, for example, 0.003 to 0.02 mass %. The aluminum content in the zinc alloy is, for example, 0.001 mass % to 0.03 mass %. In view of the corrosion resistance, the elements other than zinc preferably occupies 0.025 mass % to 0.08 mass % of the zinc alloy.

The negative electrode active material is usually used in a powder form. In view of the packability of the negative electrode and the diffusibility of the electrolyte in the negative electrode, the average particle diameter (D50) of the negative electrode material powder is, for example, 100 μm to 200 μm, preferably 110 μm to 160 μm. In the present specification, the average particle diameter (D50) refers to a median diameter in a volumetric particle size distribution. The average particle diameter can be measured by, for example, using a laser diffraction/scattering type particle size distribution analyzer.

In the following, an example of the alkaline dry battery of an embodiment of the present disclosure is described further with reference to the drawings. The present invention, however, is not limited to the following embodiment. Modification can be made as appropriate without departure from the scope in which the effect of the present invention can be exerted. Furthermore, any combination with another embodiment is possible.

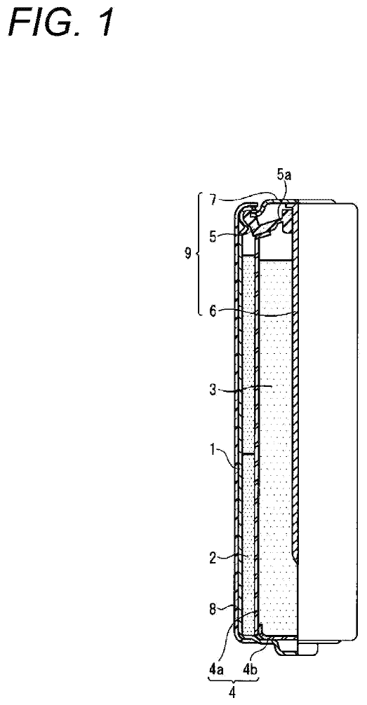

FIG. 1 is a front view of an alkaline dry battery according to one embodiment of the present disclosure, with one half side shown in cross-section. FIG. 1 illustrates an example of an inside-out type cylindrical battery. As illustrated in FIG. 1, the alkaline dry battery includes a hollow cylindrical positive electrode 2, a gel negative electrode 3 disposed in the hollow of the positive electrode 2, a separator 4 interposed therebetween, and an electrolyte, which are all housed in a bottomed cylindrical battery case 1 serving as a positive electrode terminal. The electrolyte used here is an aqueous alkaline solution.

The positive electrode 2 is disposed to be in contact with the inner wall of the battery case 1. The positive electrode 2 includes a manganese dioxide and an electrolyte. In the hollow of the positive electrode 2, the gel negative electrode 3 is packed, with the separator 4 interposed therebetween. The negative electrode 3 usually includes a negative electrode active material containing zinc, and in addition, generally an electrolyte and a gelling agent.

The separator 4 has a bottomed cylindrical shape and retains an electrolyte. The separator 4 is constituted of a cylindrically-shaped separator 4a and a bottom paper 4b. The separator 4a is disposed along the inner surface of the hollow of the positive electrode 2, to provide insulation between the positive electrode 2 and the negative electrode 3. The separator disposed between the positive electrode and the negative electrode means a cylindrical separator 4a. The bottom paper 4b is disposed at the bottom of the hollow of the positive electrode 2, to provide insulation between the negative electrode 3 and the battery case 1.

The opening of the battery case 1 is sealed with a sealing unit 9. The sealing unit 9 includes a gasket 5, a negative electrode terminal plate 7 serving as a negative electrode terminal, and a negative electrode current collector 6. The negative electrode current collector 6 is inserted into the negative electrode 3. The gasket 5 is provided with a safety valve having an annular thin-walled portion 5a. The negative electrode current collector 6 has a nail-like shape having a head and a shank, and the shank is passed through a through-hole provided in the center cylindrical portion of the gasket 5. The head of the negative electrode current collector 6 is welded to the flat portion at the center of the negative electrode terminal plate 7. The opening end of the battery case 1 is crimped onto the flange at the circumference of the negative electrode terminal plate 7, via the peripheral end portion of the gasket 5. The outer surface of the battery case 1 is wrapped with an outer label 8.

A detailed description will be given below of the alkaline dry battery.

### (Negative Electrode)

The negative electrode is obtained by mixing a Zn-containing negative electrode active material (zinc, zinc alloy, or other powder), a gelling agent, and an electrolyte. The additive may be included only in the electrolyte, but in that case as well, the negative electrode includes the electrolyte, and therefore it can be considered that the negative electrode includes the additive.

The gelling agents are not restricted, but water-absorbent polymers, for example, can be used. Examples of the water-absorbent polymer include polyacrylic acid and sodium polyacrylate.

The gelling agent in the negative electrode is added in an amount of, for example, 0.5 to 2.5 parts by mass per 100 parts by mass of the negative electrode active material.

### (Negative Electrode Current Collector)

Examples of the material of the negative electrode current collector inserted into the gel negative electrode include a metal and an alloy. The negative electrode current collector preferably contains copper, and may be made of, for example, an alloy containing copper and zinc, such as brass. The negative electrode current collector may be plated with tin or the like, if necessary.

### (Positive Electrode)

The positive electrode usually includes a manganese dioxide serving as a positive electrode active material, and in addition, an electrically conductive agent and an electrolyte. The positive electrode may further include a binder, as needed.

The manganese dioxide is preferably an electrolytic manganese dioxide. The manganese dioxide has a crystal structure, such as an α-type, a β-type, a γ-type, a δ-type, an ε-type, a η-type, a λ-type, and a ramsdellite-type crystal structure.

The manganese dioxide is usually used in a powder form. In view of the packability of the positive electrode and the diffusibility of the electrolyte in the positive electrode, the average particle diameter (D50) of the manganese dioxide is, for example, 25 to 60 μm.

Examples of the conductive agent include carbon black, such as acetylene black, and an electrically conductive carbon material, such as graphite. The graphite may be natural graphite, artificial graphite, and the like. The conductive agent may be in the form of fibers or the like, but is preferably in the form of powder. The average particle diameter (D50) of the conductive agent is, for example, 3 to 20 μm.

The content of the conductive agent in the positive electrode per 100 parts by mass of the manganese dioxide may be, for example, 3 to 10 parts by mass, and preferably 5 to 9 parts by mass.

The positive electrode can be formed by, for example, compression-molding a positive electrode material mixture including a positive electrode active material, an electrically conductive agent, an electrolyte, and if necessary, a binder, into a pellet shape. The positive electrode material mixture may be formed into flakes or granules beforehand and classified if necessary, and then compression-molded into a pellet shape.

### (Separator)

Examples of the material of the separator include cellulose and polyvinyl alcohol. The separator may be, for example, a nonwoven fabric mainly composed of fibers of the above material, or a cellophane- or polyolefin-based microporous film. A nonwoven fabric and a microporous film may be used in combination. Examples of the nonwoven fabric include a mixed nonwoven fabric mainly composed of cellulose fibers and polyvinyl alcohol fibers, and a mixed nonwoven fabric mainly composed of rayon fibers and polyvinyl alcohol fibers.

The separator has a thickness of, for example, 100 to 300 μm. The separator preferably has the above-described thickness as a whole, and when the sheet forming the separator is thin, a plurality of sheets may be placed on top of another to give the above-described thickness.

### (Electrolyte)

The electrolyte is retained in the positive electrode, the negative electrode, and the separator. The electrolyte is, for example, an aqueous alkaline solution containing a potassium hydroxide. The potassium hydroxide concentration in the electrolyte is preferably 20 to 50 mass %. The electrolyte may further contain a zinc oxide. The zinc oxide concentration in the electrolyte is, for example, 1 to 5 mass %.

### (Gasket)

Examples of the gasket material include polyamide, polyethylene, and polypropylene. The gasket can be produced by, for example, transfer molding using the above material, into a predetermined shape. The gasket is usually provided with a thin-walled portion for explosion-proof purpose. The thin-walled portion preferably is annular in shape from the viewpoint of facilitating rupture. A gasket 5 of FIG. 1 has an annular thin-walled portion 5a. From the viewpoint of making it easier to break thin-walled portions when internal pressure increases, 6,10-nylon, 6,12-nylon, and polypropylene are preferred as the material of the gasket.

### (Battery Case)

The battery case may be, for example, a bottomed cylindrical metal case. The battery case is made of, for example, a nickel-plated steel sheet. In order to improve the adhesion between the positive electrode and the battery case, the battery case is preferably a metal case whose inner surface is covered with carbon coating.

The present disclosure will be described in detail below with reference to Examples and Comparative Examples. The present invention, however, is not limited to the following Examples.

### Example 1

An AA-size cylindrical alkaline dry battery (LR6) as illustrated in FIG. 1 was produced in procedures (1) to (3) described below.

### (1) Positive Electrode Production

An electrolytic manganese dioxide powder (average particle diameter (D50): 35 μm) serving as a positive electrode active material was mixed with a graphite powder (average particle diameter (D50): 8 μm) serving as an electrically conductive agent, to give a mixture. The mass ratio of the electrolytic manganese dioxide powder to the graphite powder was set to 92.4:7.6. The electrolytic manganese dioxide powder used here had a specific surface area of 41 m²/g. An electrolyte was added to the mixture, which was stirred sufficiently and then compression-molded into a flake form, to give a positive electrode material mixture. The mass ratio of the mixture to the electrolyte was set to 100:1.5.

The flake form of the positive electrode material mixture was crushed into a granular form, and classified through a 10- to 100-mesh sieve. Then, 11 g of the resultant granules were compression-molded into a predetermined hollow cylindrical shape of 13.65 mm in outer diameter, to form a positive electrode pellet 2. Two pellets were produced.

### (2) Negative Electrode Production

A zinc alloy powder (average particle diameter (D50) 130 μm) serving as a negative electrode active material, an electrolyte, and a gelling agent were mixed, to give a gel negative electrode 3. The electrolyte used here had the same composition as that used for the production of the positive electrode.

The zinc alloy used here was a zinc alloy (ZnBiAlIn) containing 0.02 mass % of indium, 0.01 mass % of bismuth, and 0.005 mass % of aluminum.

The gelling agent used here was a mixture of a cross-linked branched polyacrylic acid and a highly cross-linked linear sodium polyacrylate.

### (3) Electrolyte Preparation

For the electrolyte, an aqueous alkaline solution including potassium hydroxide (concentration 35 mass %) and zinc oxide (concentration 2 mass %), and potassium phthalimide as an additive was used. The amount of potassium phthalimide was adjusted to be 0.025 parts by mass relative to 100 parts by mass of the negative electrode active material.

### (4) Alkaline Dry Battery Assembly

A battery case 1 was obtained by coating the inner surface of a bottomed cylindrical battery case (outer diameter: 13.80 mm, wall thickness of cylindrical portion: 0.15 mm, height: 50.3 mm) made of nickel-plated steel sheet with a carbon film of approximately 10 μm thickness by applying Varniphite manufactured by Nippon Graphite Industries, Ltd. After inserting two positive electrode pellets vertically into the battery case 1, the positive electrode pellets were pressurized to form a positive electrode 2 that was in close contact with the inner wall of the battery case 1. A bottomed cylindrical separator 4 was placed inside the positive electrode 2, and then, an electrolyte was injected thereto, to impregnate the separator 4. These were allowed to stand in this state for a predetermined period of time, to allow the electrolyte to permeate from the separator 4 into the positive electrode 2. Thereafter, 6 g of the gel negative electrode 3 was packed inside the separator 4.

The separator 4 was constituted of a cylindrically-shaped separator 4a and a bottom paper 4b. The cylindrically-shaped separator 4a and the bottom paper 4b were formed using a sheet of mixed nonwoven fabric (basis weight: 28 g/m²) mainly composed of rayon fibers and polyvinyl alcohol fibers mixed in a mass ratio of 1:1. The thickness of the nonwoven fabric sheet used for the bottom paper 4b was 0.27 mm. The separator 4a was constituted by winding a 0.09-mm-thick nonwoven fabric sheet in three layers.

Generally, a sealing unit is disposed at an opening of the battery case 1, and the opening of the battery case 1 is sealed, but here, for the evaluation below, the opening was not sealed, and an alkaline dry battery A1 with its opening opened was produced.

### Example 2

An alkaline dry battery A2 was made in the same manner as in Example 1, except that in the preparation of the electrolyte, instead of potassium phthalimide, phthalimide was used as the additive.

### Comparative Example 1

An alkaline dry battery B1 was made and evaluated in the same manner as in Example 1, except that in the preparation of the electrolyte, potassium phthalimide was not used.

### Comparative Example 2

An alkaline dry battery B2 was made and evaluated in the same manner as in Example 1, except that in the preparation of the electrolyte, instead of potassium phthalimide, polyoxyethylene alkyl ether phosphoric acid ester (noted as phosphoric acid ester in Table 1) was used.

### [Evaluation]

The batteries A1, A2, B1, and B2 produced as described above were immersed in liquid paraffin, and stored for one month at 70° C. in that state, and gas generated from the battery during the storage period was collected. Table 1 shows the ratio of the amount of gas of the batteries A1, A2, and B2, setting the amount of gas generated from the battery B1 as 100%.

TABLE 1

| | | Amount added | Amount |
|---|---|---|---|
| | | (vs 100 parts by mass of | of gas |
| Battery | Additive | Negative Electrode active material) | (%) |
| A1 | Potassium | 0.025 parts by mass | 27 |
| | phthalimide | | |
| A2 | Phthalimide | 0.025 parts by mass | 36 |
| B1 | None | 0 | 100 |
| B2 | Phosphoric | 0.025 parts by mass | 60 |
| | acid ester | | |

Table 1 shows that by including a predetermined cyclic compound in the electrolyte, generation amount of hydrogen gas is reduced, and increase in the battery internal pressure is suppressed. Also, it shows that the cyclic compound has significantly high effects of reducing the hydrogen gas generation amount compared with polyoxyethylene alkyl ether phosphoric acid ester recommended by Patent Literature 2.

### INDUSTRIAL APPLICABILITY

The present disclosure can be used for aqueous primary batteries in which the negative electrode active material includes zinc, and an aqueous solution electrolyte is included, for example, alkaline dry batteries and manganese dry batteries.

### REFERENCE SIGNS LIST

1 battery case
2 positive electrode
3 negative electrode
4 bottomed cylindrical separator
4a cylindrical separator
4b bottom paper
5 gasket
5a thin-walled portion
6 negative electrode current collector
7 negative electrode terminal plate
8 outer label
9 sealing unit

1. An aqueous primary battery comprising: a positive electrode, a negative electrode, a separator interposed between the positive electrode and the negative electrode, and an aqueous solution electrolyte included in the positive electrode, the negative electrode, and the separator, wherein
the negative electrode and/or the electrolyte includes an additive,
the negative electrode includes a negative electrode active material,
the negative electrode active material includes zinc,
the additive includes a cyclic compound, and
the cyclic compound has a first ring including a —N—CO— structure, and a second ring that shares at least two atoms with the first ring.

2. The aqueous primary battery of claim 1, wherein the cyclic compound is at least one selected from the group consisting of:
a phthalimide compound represented by a general formula (1): 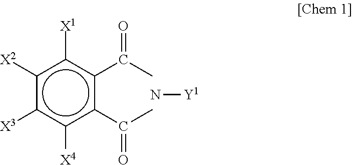
(in the general formula (1), X1 to X4 are each independently a hydrogen atom, a fluorine atom, a chlorine atom, a bromine atom, an iodine atom, or an alkyl group having 1 to 3 carbon atoms, and Y1 is a hydrogen atom or an alkali metal atom),
a phthalimidine compound represented by a general formula (2): 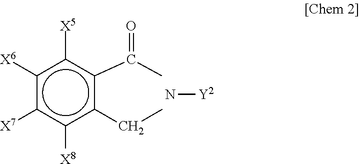
(in the general formula (2), X5 to X8 are each independently a hydrogen atom, a fluorine atom, a chlorine atom, a bromine atom, an iodine atom, or an alkyl group having 1 to 3 carbon atoms, and Y2 is a hydrogen atom or an alkali metal atom), and
a tetrahydro phthalimide compound represented by a general formula (3): 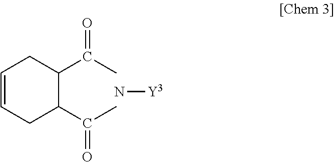
(in the general formula (3), Y3 is a hydrogen atom or an alkali metal atom).

3. The aqueous primary battery of claim 2, wherein the cyclic compound is at least one selected from the group consisting of phthalimide and potassium phthalimide.

4. The aqueous primary battery of claim 1, wherein an amount of the cyclic compound is 0.005 parts by mass or more and 0.05 parts by mass or less relative to 100 parts by mass of the negative electrode active material.

5. The aqueous primary battery of claim 1, wherein the aqueous primary battery is an alkaline dry battery or a manganese dry battery.
